(19) United States
(12) Patent Application Publication
(10) Pub. No.: US 2002/0024289 A1
(43) Pub. Date: Feb. 28, 2002

(54) Color cathode ray tube, manufacturing method thereof, and composite material for a vapor deposition

(76) Inventors: Masaru Nikaido, Yokosuka-shi (JP); Hitoshi Shiozawa, Honjo-shi (JP); Yoshihiro Tajima, Tano-gun (JP)

Correspondence Address: PILLSBURY WINTHROP LLP, 1600 TYSONS BOULEVARD, MCLEAN, VA, 22102, US

(21) Appl. No.: 09/934,690

(22) Filed: Aug. 23, 2001

(30) Foreign Application Priority Data
Aug. 25, 2000 (JP) P2000-256063

(51) Int. Cl. H01J 29/28

(52) U.S. Cl. 313/466

(57) ABSTRACT

A color cathode ray tube comprises a metal back layer containing a co-vapor deposition layer of a first metal such as Al or the like and a metal oxide high in heat absorptivity, such as Fe₃O₄, NiO, NiFe₂O₄, Cr₂O₃, MnO₂ or the like. The metal back layer may be manufactured at low costs and may be high in heat absorption and may not deteriorate in reflectivity in the course of heating.

In addition, the metal back layer is formed by means of vacuum deposition by the use of composite material for a vapor deposition. The composite material comprises bar-like core formed of a mixture of metal powder such as Al and metal oxide powder high in heat absorptivity and a clad formed of metal such as Al or the like covering the core in close proximity therewith. The composite material is stable in vapor deposition properties.

### BACKGROUND OF THE INVENTION

1. Field of the Invention

The present invention relates to a color cathode ray tube having a metal back layer high in heat absorption characteristics on a phosphor layer of an inner panel surface and a manufacturing method thereof. Further, the present invention relates to composite material for forming the metal back layer high in heat absorption by means of a vapor deposition.

2. Related Art

In general, a color cathode ray tube comprises an electron gun assembly generating three electron beams, a phosphor screen emitting in three colors of blue, green and red at the collision of the electron beams, and a shadow mask in a glass vacuum envelope (glass bulb). The shadow mask carries out color-selection so that each of the three electron beams from the electron gun assembly impinges on a phosphor layer of a corresponding color, respectively.

On the phosphor layer, a metal back layer of an aluminum film or the like is formed by means of vacuum deposition process or the like. The metal back layer reflects light emitted from the phosphor layer and directing toward the electron gun assembly, thereby enhancing brightness and stabilizes a potential of the phosphor layer. Furthermore, the metal back layer prevents damages of the phosphor layers from ions generated through ionization of residual gas in the vacuum envelope.

The shadow mask is arranged facing the phosphor screen formed on the inner surface of the panel. The electron beam emitted from the electron gun assembly goes through a lot of holes formed on an effective surface of the shadow mask, thereby landing only on the phosphor layer geometrically in one to one relationship with the hole.

Accordingly, deviation in the geometrical relationship between the holes of the shadow mask and the phosphor layers cannot cause the electron beam to land on right positions. As a result, good color display cannot be implemented. As one reason causing such a mislanding of the electron beam, deformation of the shadow mask due to thermal expansion is cited.

That is, approximately 20% of total electron beams go through the holes of the shadow mask to be effective electron beams. The remaining approximate 80% of the electron beams impinge on the shadow mask, being absorbed and converted into heat energy, resulting in raising the temperature of the shadow mask. As a result, the shadow mask expands thermally during the operation to result in a phenomenon so-called doming. Relative positions between the holes of the shadow mask and the phosphor layers are altered, causing mislanding of the electron beams on the phosphor screen, resulting in color drift (purity drift) on a screen.

The doming is classified into entire doming and local doming. The entire doming is due to a temperature rise of the entire shadow mask and the local doming, when the electron beams are heavily poured into a particular area of the screen, is caused due to partial deformation of the shadow mask. The entire doming has short term doming and long term doming.

The short term doming occurs immediately after the start-up of the cathode ray tube. While the shadow mask, being heated abruptly, thermally expands, a mask frame large in heat capacity scarcely expands thermally. As a result, the shadow mask deforms in dome. In the short term doming, the holes of the shadow mask drift in a radius direction of curvature of the shadow mask. In the long period doming, the mask frame large in heat capacity expands thermally together with the shadow mask. As a result, the holes of the shadow mask shift in a direction perpendicular to a tube axis.

On the other hand, the local doming may occur at any time during the operation. In the local doming, similarly as the short term doming, the holes of the shadow mask drift in a direction of radius of curvature. Deformation of the shadow mask is larger than that in the short term doming.

Recently, as monitors of computers and work stations, liquid crystal displays are increasing in the ratio in view of flatness of the panel surface and space saving. In coping with this, flat type cathode ray tubes having flat panel surface and slim type cathode ray tubes decreased in its depth has been developed. Furthermore, in cathode ray tubes for entertainments to say TVs, in addition to becoming larger and wider, flat type ones less in extraneous light reflection and less in image distortion are rapidly coming into wide use from point of view of a human engineering

In these color cathode ray tubes, not only an external surface of the panel is made flat, but an internal surface thereof also is formed nearly flat. The shadow mask is formed in conformity with a curvature of the internal surface of the panel. As the panel is flattened, the shadow mask has to be reduced in its curvature. As a result, doming-resistance characteristics of the shadow mask is decreased largely.

That is, while in the conventional color cathode ray tubes, the doming can be suppressed from occurring through design changes of mask frame system or that of lens for exposing the phosphor screen, the doming cannot be controlled by the above design changes alone in the flat type color cathode ray tubes. In addition, the local doming that is difficult to suppress only through the design changes of the mask frame system or that of lens increases in the deformation as the shadow mask becomes more flat, resulting in exceeding an allowable value.

So far, in order to suppress the doming due to thermal expansion of the shadow mask, a dispersion solution of graphite powder is coated on the metal back layer of the phosphor screen and dried to form a film having high heat absorption (also high in heat emission). Thereby, the heat emission from the shadow mask is promoted to lower the temperature of the shadow mask.

This method demands a separate process for forming the film having high heat absorption. In addition, since the film having high heat absorption is easily peeled off, product yield is lowered and failure in voltage-withstand properties is caused during the use.

Japanese Patent Laid-open Application No. HEI 11 (1999)-213884 discloses a countermeasure to such problems, in which a mixture of aluminum powder and carbon powder is sintered by hot pressing to form a pellet, and the mixture in the pellet is evaporated on a metal back layer to form a film having high heat absorption.

However, in this method, the obtained film is insufficient in heat absorption due to a limiting content of carbon that can be co-vapor deposited together with aluminum. In addition, conditions of vapor deposition are varied with ease due to oxidation of aluminum or moisture absorption on carbon powder. Since aluminum reacts with carbon to form carbide during the vapor deposition, deposition residue remains much and manufacturing cost of vapor deposition material is extremely high.

Furthermore, clad-wire type vapor deposition material is disclosed in Japanese Patent Laid-open Application No. 2000-87220, in which cladding material consisting of metal having low vapor pressure (Al, for instance) covers the surroundings of a core consisted of metal having high vapor pressure (Ni, Fe, for example). By the use of the vapor deposition material, a heat absorption film (metal back) is formed on an internal surface of the cathode ray tube.

The metal back formed by this method, immediately after the deposition, has a structure in which an Al layer and a Ni layer (or Fe layer) are stacked in turn from a side closer to the phosphor screen. However, in the later heating process in manufacturing of the cathode ray tube, Al and Ni diffuse mutually to result in that Ni diffuses into the Al layer close to the phosphor screen. Thereby, light reflectivity of the Al layer deteriorates to from 94 to 97% of that of a pure Al layer. In the metal back where an Al layer and a Fe layer are stacked, due to the diffusion of Fe into the Al layer, reflectivity of the Al layer goes down to from 93 to 96% that of a pure Al layer. In addition, there are problems that Ni or Fe diffuses closer to the Al layer adjacent to the phosphor screen to deteriorate the phosphors themselves.

### BRIEF SUMMARY OF THE INVENTION

The present invention is carried out to overcome these problems. An object of the present invention is to provide a color cathode ray tube that has a metal back layer that does not cause deterioration of reflectivity during heating in addition to low cost and high heat absorption and a manufacturing method thereof. Furthermore, another object of the present invention is to provide composite material stable in deposition properties for forming such a metal back layer.

A first aspect of the present invention is a color cathode ray tube comprising a transparent panel, a phosphor layer formed on an internal surface of the panel and a metal back layer disposed on the phosphor layer. The metal back layer comprises a co-vapor deposition layer of a first metal and a metal oxide having high heat absorptivity.

In the first aspect, the metal back layer may comprise a layer of a second metal formed on the phosphor layer and a co-vapor deposition layer formed on the layer of the second metal. The second metal may be aluminum or aluminum alloy.

In the first aspect, the first metal constituting the co-vapor deposition layer may be aluminum or aluminum alloy. Furthermore, the metal oxide that has high heat absorptivity may be at least one transition metal oxide selected from Fe₂O₃, Fe₃O₄, NiO, NiFe₂O₄, Cr₂O₃, MnO₂ and CoO.

A second aspect of the present invention is a manufacturing method of a color cathode ray tube, comprising forming a phosphor layer on an internal surface of a transparent panel and forming a metal back layer on the phosphor layer. The forming of the metal back layer comprises forming a co-vapor deposition layer of a first metal and a metal oxide having high heat absorptivity.

In the second aspect of the present invention, the forming of a metal back layer may comprise forming a vapor deposition layer composed of a second metal on a phosphor layer and forming a co-vapor deposition layer on the vapor deposition layer. The second metal may be aluminum or aluminum alloy.

Furthermore, in the second aspect of the present invention, the first metal forming a co-vapor deposition layer may be aluminum or aluminum alloy. The metal oxide that has high heat absorptivity may be at least one transition metal oxide selected from Fe₂O₃, Fe₃O₄, NiO, NiFe₂O₄, Cr₂O₃, MnO₂ and CoO.

A third aspect of the present invention is composite material for a vapor deposition comprising a core and a clad covering the core and disposed in close contact therewith. The core is composed of a mixture of powders of the first metal and of the metal oxide having high heat absorptivity and the clad is composed of the second metal.

In the third aspect of the present invention, the first metal may be aluminum or aluminum alloy. The second metal also may be aluminum or aluminum alloy. Furthermore, the metal oxide having high heat absorptivity may be at least one of transition metal oxide selected from Fe₂O₃, Fe₃O₄, NiO, NiFe₂O₄, Cr₂O₃, MnO₂ and CoO.

In the present color cathode ray tube, the metal back layer comprises the co-vapor deposition layer of the first metal such as aluminum or aluminum alloy and the metal oxide such as Fe₂O₃, Fe₃O₄, NiO, NiFe₂O₄ or the like. The metal back layer, while maintaining an original function such as reflecting light emitted from phosphor and stabilizing a potential, does not peel and fall off during the use and has stable and high heat absorption properties. Furthermore, in the metal back layer, even after the heating process in manufacturing of color cathode ray tubes, components do not diffuse mutually and reflectivity does not deteriorate. Accordingly, in the present color cathode ray tube, brightness is high and the doming of the shadow mask is largely suppressed and characteristics of a display are excellent.

The metal back layer may be easily formed by means of vacuum deposition of composite material for a vapor deposition of the present invention. That is, by only changing the conventional deposition source such as Al or the like to the present composite material, the metal back layer having high heat absorptivity may be formed without largely changing or adding the process. In addition, the composite material of the present invention may be manufactured at the same price as that of the conventional vapor deposition material.

In the formation of the metal back layer in the present color cathode ray tube, another formation method may be adopted without employing the present composite material. At that time, a boundary between the deposition layer of the second metal and the co-vapor deposition layer may be ambiguously formed.

### BRIEF DESCRIPTION OF THE DRAWINGS

FIG. 1 is a sectional view showing a first embodiment of composite material for a vapor deposition of the present invention.

FIG. 2 is a graph showing measurements of concentration of each element in a metal back layer formed by the use of composite material of the first embodiment.

FIGS. 3A and 3B are graphs showing measurements results of concentration profile of each element in a metal back layer formed by the use of clad wire type vapor deposition material disclosed in known example immediately after the deposition and after the heat treatment, respectively.

FIG. 4 is a sectional view showing a configuration of a color cathode ray tube that is a second embodiment of the present invention.

FIG. 5 is a sectional view showing a configuration of a metal back layer formed by the use of composite material of the first embodiment.

### DETAILED DESCRIPTION OF THE INVENTION

In the following, embodiments of the present invention will be explained.

FIG. 1 is a transverse sectional view showing a configuration of an embodiment of composite material for a vapor deposition involving the present invention. In the figure, reference numeral 1 denotes a rod-like core formed of a mixture of powders of the first metal and the metal oxide having high heat absorptivity, reference numeral 2 denoting a cylindrical clad (sleeve) formed of the second metal disposed covering the core 1 in close contact therewith.

In the composite material of the present embodiment, as the powder of the first metal for forming the core 1, aluminum (Al) powder, or aluminum alloy powder containing substantial Al and a slight amount of magnesium (Mg) and manganese (Mn) can be cited. Any metal that does not deteriorate characteristics of phosphors, is small in electron reflection coefficient and is malleable and ductile may be used without restricting to the above metal.

As the second metals for forming the clad 2, the above Al or Al alloy may be used. Any metal that does not deteriorate characteristics of phosphors, is small in electron reflection coefficient, and is malleable and ductile may be used. Furthermore, though the first metal for forming the core 1 and the second metal for forming the clad may be either the same kind or the different kinds, a combination is preferably selected so that the first metal vaporizes simultaneously with the second metal or belatedly than the second metal.

As the metal oxides having high heat absorptivity for forming the core 1 together with the first metal, one or more kinds of transition metal oxide may be selected among Fe₂O₃, Fe₃O₄, NiO, NiFe₂O₄, Cr₂O₃, MnO₂ and CoO. Any metal oxide that has high heat absorptivity, does not decompose at vacuum deposition, and is low in moisture absorption and stable as powder may be used irrespective of the above oxides. Furthermore, in order that the metal back layer prevents electric charges from building-up there by endowing conductive properties to the phosphor layers, the metal oxides excellent in conductive properties such as NiO or NiFe₂O₄ are particularly preferable.

For a particle diameter of the first metal powder for forming the core 1, an average particle diameter is preferable to be in the range from 10 to 100 μm, the maximum particle diameter being 250 μm or less. For a particle diameter of the metal oxide powder having high heat absorptivity, an average particle diameter is preferable to be 30 μm or less, the maximum particle diameter being 100 μm or less. In the case of the particle diameters of the first metal powder and metal oxide powder being outside of the above ranges, the first metal and the metal oxide having high heat absorptivity may be efficiently co-deposited with difficulty. In particular, the particle diameter of the metal oxide powder is preferable to be as small as possible so that the particles of the first metal vaporize with ease surrounding particles of the metal oxide having high heat absorptivity. The metal oxide powder is preferable to be uniformly mixed with the first metal powder.

In addition, a mixing ratio of the metal oxide powder of high heat absorption properties is preferable to be in the range from 4 to 20 atomic % in the mixture for forming the core 1. When the ratio of the metal oxide powder is less than 4 atomic %, the metal back layer having sufficiently high heat absorptivity may not be obtained. When the ratio of the metal oxide powder exceeds 20 atomic %, not only malleability and ductility at manufacturing of the composite material for a vapor deposition largely deteriorate, but also the first metal and the metal oxide are co-deposited with difficulty, resulting in much deposition residue.

In manufacturing the composite material for a vapor deposition of the present embodiment, powders of the first metal and metal oxide of high heat absorption properties are mixed and molded into a round bar, thereafter the molded body being inserted into a sleeve made of the second metal such Al or the like, thereby filling without leaving a gap therebetween. One end of the sleeve is sealed and air inside is evacuated from the other end, thereafter the other end is also sealed. The evacuation of the inside air is done to obtain strong adhesion between the core and the clad.

Next, the composite material in which the molded body is inserted is drawn and the molded body and the sleeve are integrated. The drawing process may be any one of cold, warm and hot drawings. Care must be sufficiently paid on for fear that the surface is oxidized since oxidization of the surface damages deposition properties.

The metal back layer of the color cathode ray tube is formed by the use of the composite material of the present embodiment in the following ways.

That is, with the composite material of the present embodiment, vacuum deposition is implemented by means of ordinary resistance heating method. As the heating method at the deposition, other than the resistance heating method, high frequency induction heating, electron beam heating or the like may be employed. First, the second metal (Al or Al alloy) constituting the clad is evaporeted, then the mixture of the first metal and the metal oxide of high heat absorption both constituting the core vaporizes into a vacuum.

The metal oxide of high heat absorption has extremely high melting point (melting point of Fe₃O₄ is 1600° C. for instance) and cannot be vaporized at ordinary heating temperatures (approximately 700° C.). However, in heating in a state mixed with the first metal such as Al, the above metal oxide is considered to vaporize together surrounded by particles of the first metal. The metal particles such as Al or the like work as a carrier of the metal oxide particles and vaporize into a vacuum with the metal oxide particles contained therein when vaporizing. As a result, the particles of the first metal and the particles of metal oxide of high heat absorption may be deposited together at temperatures of approximately 700° C.

Thus, first, a deposition layer composed of the second metal (Al or the like) constituting the clad is formed and thereon a co-vapor deposition layer of the first metal (Al or the like) and the metal oxide of high heat absorption is formed to complete a metal back layer. The co-vapor deposition layer contains the metal oxide having high heat absorptivity and is extremely excellent in heat absorption properties. The boundary between the deposition layer of the second metal and the co-vapor deposition layer formed thereon may be ambiguous in some cases.

In the formation of the metal back layer by the use of the composite material of the present embodiment, the deposition layer composed of the second metal and the co-vapor deposition layer of the first metal and the metal oxide of high heat absorption are preferable to be continuously formed in a vacuum. After the second metal is deposited, exposed to air and evacuated again, the co-vapor deposition layer may be formed.

By depositing the composite material of the present embodiment, the metal back layer that maintains desirable characteristics such as stabilizing reflection of light emission from the phosphor and potential may be formed. In addition, the metal back layer is stable because of peeling and falling with difficulty during the use and has high heat absorption properties. Further, by only replacing the existing deposition source such as Al or the like to the composite material of the embodiment, the metal back layer of high heat absorption may be formed without accompanying large addition or alteration of the process.

Furthermore, in the present metal back layer, even after undergoing the heating process in the manufacturing of the color cathode ray tube, the components do not mutually diffuse and reflectivity does not deteriorate. Accordingly, the color cathode ray tube high in brightness and largely improved in the doming-resistance characteristics of the shadow mask may be obtained.

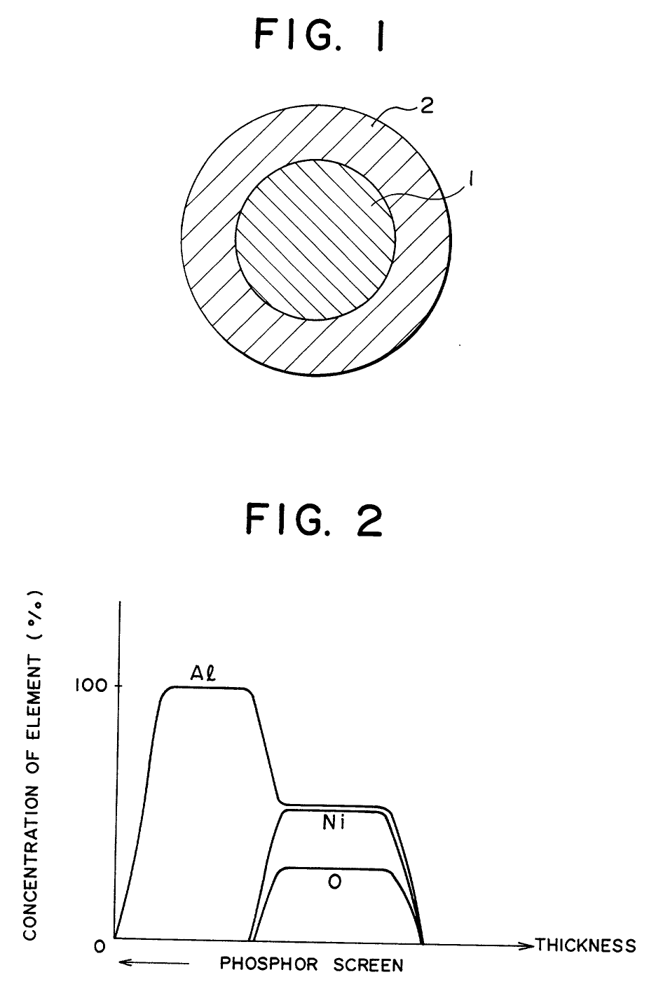

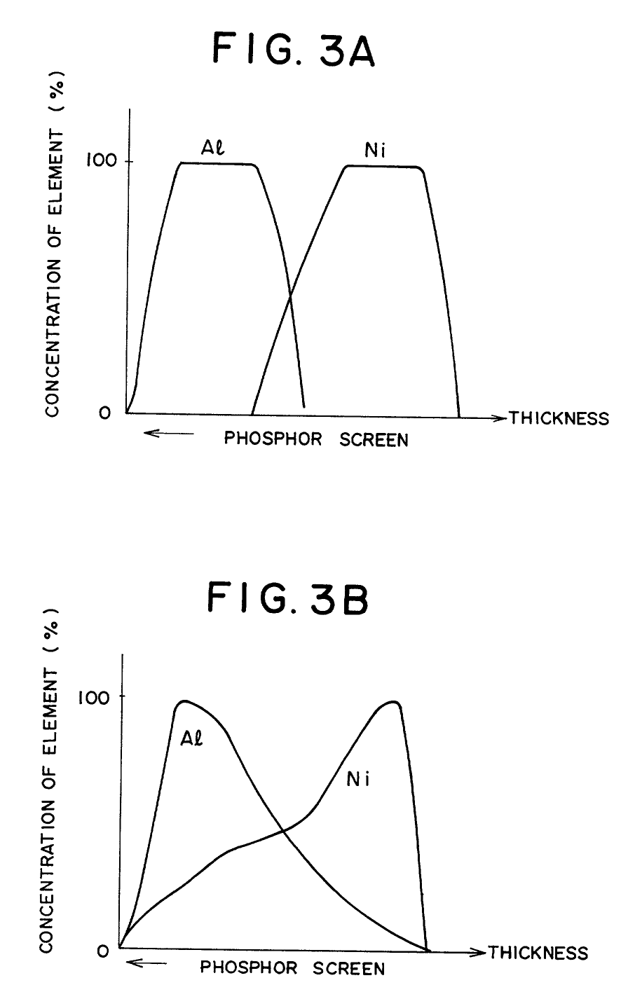

With the metal back layer formed by the use of the composite material of the embodiment (has a configuration in which in the surroundings of a core made of a mixture of Al powder and NiO powder, a clad of Al is arranged) and a metal back layer formed by the use of clad wire type vapor deposition material disclosed in Japanese Patent Laid-open Application No. 2000-87220, element concentration profile (in thickness direction) of the layers are analyzed and measured before and after heating. Measurements are implemented with Auger electron spectroscopy. The measurements of the metal back layer by the use of the composite material of the embodiment are shown in FIG. 2. In the present metal back layer, there are scarcely found changes in element concentrations before and after the heating. The measurements of the metal back layer formed by the use of the known vapor deposition material are shown in FIGS. 3A and 3B, respectively, for immediately after the deposition and after the heating.

From these graphs, the following is confirmed. That is, in the metal back layer formed by the use of the composite material of the present embodiment, Ni atom, being strongly bonded with oxygen, even after undergoing the heating, does not diffuse into the Al layer. On the contrary, in the metal back layer formed by the use of the known vapor deposition material, immediately after the deposition, the Al and Ni layers are stacked in turn from a side closer to the phosphor screen as shown in FIG. 3A. However, after the heating, Al and Ni diffuse mutually to be rather high in Ni concentration of the Al layer in closer contact with the phosphor screen.

Next, the color cathode ray tube having the metal back layer formed by the use of the composite material of the present embodiment will be explained with reference to the drawings.

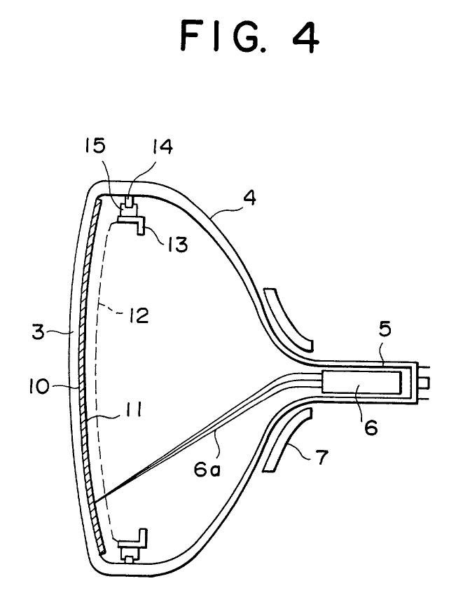

The color cathode ray tube, as shown in FIG. 4, comprises an envelope having a panel 3, a funnel 4 and a neck 5 all made of glass, and maintaining a vacuum inside thereof. Inside the neck 5 of the envelope, an electron gun assembly 6 emitting three electron beams 6a is disposed, and outside the funnel 4 a deflection yoke 7 is disposed to deflect the electron beams 6a by a generated magnetic field.

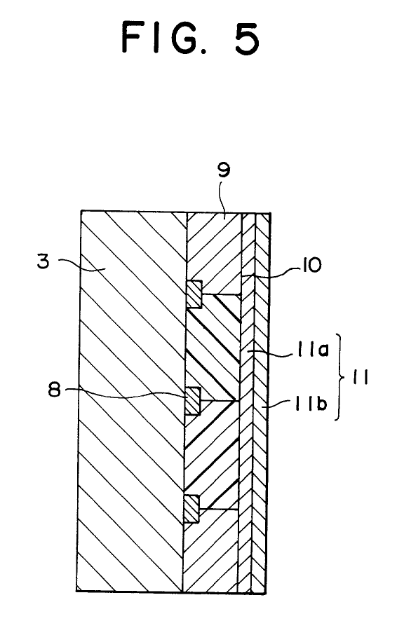

As shown enlarged in FIG. 5, the phosphor screen 10 comprising black matrix 8 and phosphor layers 9 of the respective colors arranged in a prescribed pattern are formed on an internal surface of the panel 3, and the metal back layer 11 is formed thereon.

The metal back layer 11 is formed by vacuum depositing the composite material of the embodiment and has the following configuration. That is, the metal back layer 11 comprises a first vapor deposition layer 11a and a co-vapor deposition layer 11b. The first vapor deposition layer 11a is formed by the deposition of the second metal (Al for instance) constituting the clad of the composite material. The co-vapor deposition layer 11b (co-vapor deposition layer of the first metal such as Al and metal oxide of high heat absorption) of the components constituting the core is formed on the first vapor deposition layer 11a.

The boundary of the first vapor deposition layer 11a and the co-vapor deposition layer 11b may be ambiguous in some cases. A total thickness of the metal back layer 11 is preferably set in the range from 0.1 to 0.5 mm.

Furthermore, inside the panel 3, the shadow mask 12 is arranged facing the phosphor screen 10 to implement color selection, thereby the three electron beams 6a colliding the phosphor layers of the corresponding colors, respectively. The mask frame 13 is solidly fixed to the periphery of the shadow mask 12 (skirt portion), being latched through a spring 15 or the like to stud pins 14 planted on an internal wall of the panel 3. Color filters corresponding to emission colors of the phosphors (omitted from showing in the figure) may be disposed between the phosphor screen 10 and the panel 3 in order to improve brightness, contrast and emission chromaticity.

In such a color cathode ray tube, the metal back layer that does not peel and fall during the use in addition to possessing a desirable fundamental function and is stable and high in heat absorption is formed on the phosphor screen 10. Accordingly, the doming of the shadow mask 12 may be suppressed and characteristics of a display are largely improved.

Next, the present invention will be explained on the basis of specific embodiments. The present invention is not restricted to the following embodiments.

Embodiment 1

Gas atomized Al powder (maximum particle diameter; 150 μm, average particle diameter; 70 μm) in nitrogen of which oxygen content was 1000 ppm or less, and Fe₃O₄ powder of which maximum particle diameter was 30 μm and average particle diameter was 5 μm were prepared. These powders were mixed with a ratio (atomic ratio) of Al powder to Fe₃O₄ powder of 8.5 to 1.5. Thereafter, the powder mixture was molded by oil hydraulic press to be a bar like molded body of an outer diameter of 5 mm and a length of 30 cm.

On the other hand, a cylindrical pure Al sleeve (purity of 99.9%) of an inner diameter of 5 mm, an outer diameter of 12 mm, and a length of 35 cm was formed.

Then, the cylindrical pure Al sleeve was acid cleaned to remove an oxide film or dirt on the surface thereof. Thereafter, inside a hollow portion thereof, the molded body composed of the mixture of the Al powder and Fe₃O₄ powder was inserted. Then, one end of the pure Al sleeve was sealed and air inside thereof was evacuated, followed by sealing the other end.

Cold drawing was applied with the composite material thus obtained in the following manner. That is, the drawing was repeated to the composite material while selecting drawing dices so that a working rate a time was from 5 to 10% by reduction in area, thereby the composite material of an outer diameter 1.7 mm being obtained. Though the cold drawing was implemented in the present embodiment, warm or hot drawing could be applied.

Then, the obtained composite material was cut into a prescribed length to use for vapor deposition. That is, the composite material cut into a prescribed length was supplied in a boat for vapor deposition of resistance heating and the panel an inner surface of which had phosphor layers was disposed in a vacuum chamber. The vacuum chamber was evacuated up to a prescribed vacuum, at the prescribed vacuum electricity being passed to the boat for vapor deposition.

The boat for vapor deposition, after preheating to oust absorbed gas, was heated at a temperature of approximately 700° C. to vapor deposit the composite material, thereby a metal back layer of a thickness of from 0.1 to 0.5 mm being formed on the phosphor layers.

The metal back layer thus formed comprised the first vapor deposition layer and the co-vapor deposition layer. The first vapor deposition layer was composed of the pure Al derived from the Al sleeve (a clad). The co-vapor deposition layer was composed of Al and Fe₃O₄ deposited and formed belatedly. Heat absorptivity of the obtained metal back layer was 0.27, being extremely higher than that (0.16) of the pure Al metal back layer. In addition, there was scarcely found vapor deposition residue.

Embodiment 2

Al powder (maximum particle diameter; 70 μm, average particle diameter; 65 μm) made by means of centrifugal atomization of which oxygen content was 100 ppm or less, and NiO powder of which maximum particle diameter was 20 μm and average particle diameter was 5 μm were prepared, respectively. These powders were mixed with a ratio (atomic ratio) of Al powder to NiO powder of 9 to 1. There after, the powder mixture was molded by oil hydraulic press to be a bar like molded body of an outer diameter of 5 mm and a length of 30 cm.

On the other hand, as the clad, a cylindrical pure Al sleeve (purity of 99.9%) of an inner diameter of 5 mm, an outer diameter of 12 mm, and a length of 35 cm was prepared.

Then, the cylindrical pure Al sleeve was acid cleaned to remove an oxide film or dirt on the surface thereof. Thereafter, inside a hollow portion thereof, the molded body composed of the mixture of the Al powder and NiO powder was inserted. Then, one end of the pure Al sleeve was sealed and air inside thereof was evacuated, followed by sealing the other end.

Cold drawing was applied with the composite material thus obtained in the following manner. That is, to the composite material, the drawing was repeated while selecting drawing dices so that a working rate a time was from 5 to 10% by reduction in area, thereby the composite material of an outer diameter 1.7 mm being obtained. Though the cold drawing was implemented in the present embodiment, warm or hot drawing could be applied.

Then, the obtained composite material was cut into a prescribed length to use in vapor deposition. That is, the composite material cut into a prescribed length was supplied in a boat for vapor deposition of resistance heating and the panel an inner surface of which had phosphor layers was disposed in a vacuum chamber. The vacuum chamber was evacuated up to a prescribed vacuum, at the prescribed vacuum electricity being passed to the boat for vapor deposition.

The boat for vapor deposition, after preheating to oust absorbed gas, was heated at a temperature of approximately 700° C. to vapor deposit the composite material, thereby a metal back layer of a thickness from 0.1 to 0.5 mm being formed on the phosphor layers.

The metal back layer thus formed comprised the first vapor deposition layer and the co-vapor deposition layer. The first vapor deposition layer was composed of the pure Al derived from the Al sleeve (a clad). The co-vapor deposition layer was composed of Al and NiO deposited and formed belatedly. Heat absorptivity of the obtained metal back layer was 0.32, being extremely higher than that (0.16) of the pure Al metal back layer. In addition, there was scarcely found vapor deposition residue.

As obvious from the above explanation, in the color cathode ray tube of the present embodiment, the metal back layer does not peel and fall during the use in addition to possessing a desired fundamental function such as stabilizing reflection of emission from the phosphors and potential, and is stable and high in heat absorption. Accordingly, the doming of the shadow mask may be largely suppressed, display characteristics being improved.

Furthermore, by changing only a vapor deposition source such as the Al used for the formation of the metal back layer to the composite material of the present invention, the metal back layer high in heat absorption may be formed without accompanying large addition or alteration in the process.

Still furthermore, the composite material of the present embodiment may be produced at the cost the same with that of the existing Al vapor deposition material. Even the two-layered metal back layer may be formed by the use of composite material for a vapor deposition without causing large addition or alteration of the process.

What is claimed is:

1. A color cathode ray tube, comprising:
a transparent panel;
a phosphor layer formed on an internal surface of the panel; and
a metal back layer formed on the phosphor layer,
wherein the metal back layer comprises a co-vapor deposition layer of a first metal and a metal oxide high in heat absorptivity.

2. A color cathode ray tube as set forth in claim 1,
wherein the metal back layer comprises a layer of a second metal formed on the phosphor layer and the co-vapor deposition layer formed on the layer of the second metal.

3. A color cathode ray tube as set forth in claim 1,
wherein the first metal is one of aluminum and aluminum alloy.

4. A color cathode ray tube as set forth in claim 1,
wherein the metal oxide high in heat absorptivity is at least one transition metal oxide selected from a group of Fe₂O₃, Fe₃O₄, NiO, NiFe₂O₄, Cr₂O₃, MnO₂ and CoO.

5. A color cathode ray tube as set forth in claim 2,
wherein the second metal is one of aluminum and aluminum alloy.

6. A color cathode ray tube as set forth in claim 2,
wherein the metal oxide high in heat absorptivity is at least one transition metal oxide selected from a group of Fe₂O₃, Fe₃O₄, NiO, NiFe₂O₄, Cr₂O₃, MnO₂ and CoO.

7. A method for manufacturing a color cathode ray tube, comprising:
forming a phosphor layer on an internal surface of a transparent panel; and
forming a metal back layer on the phosphor layer,
wherein the forming of the metal back layer comprises forming a co-vapor deposition layer of a first metal and a metal oxide high in heat absorptivity.

8. A manufacturing method as set forth in claim 7,
wherein the forming the metal back layer comprises forming a vapor deposition layer composed of a second metal on the phosphor layer and forming the co-vapor deposition layer on the vapor deposition layer.

9. A manufacturing method as set forth in claim 7,
wherein the first metal is one of aluminum and aluminum alloy.

10. A manufacturing method as set forth in claim 7,
wherein the metal oxide high in heat absorptivity is at least one transition metal oxide selected from a group of Fe₂O₃, Fe₃O₄, NiO, NiFe₂O₄, Cr₂O₃, MnO₂ and CoO.

11. A manufacturing method as set forth in claim 8,
wherein the second metal is one of aluminum and aluminum alloy.

12. A manufacturing method as set forth in claim 8,
wherein the metal oxide high in heat absorptivity is at least one transition metal oxide selected from a group of Fe₂O₃, Fe₃O₄, NiO, NiFe₂O₄, Cr₂O₃, MnO₂ and CoO.

13. A composite material for a vapor deposition, comprising:
a core; and
a clad covering the core in close contact therewith,
wherein the core is formed of a mixture of powders of a first metal and a metal oxide high in heat absorptivity and the clad is formed of a second metal.

14. A composite material for a vapor deposition as set forth in claim 13,
wherein the first metal is one of aluminum and aluminum alloy.

15. A composite material for a vapor deposition as set forth in claim 13,
wherein the second metal is one of aluminum and aluminum alloy.

16. A composite material for a vapor deposition as set forth in claim 13,
wherein the metal oxide high in heat absorptivity is at least one transition metal oxide selected from a group of Fe₂O₃, Fe₃O₄, NiO, NiFe₂O₄, Cr₂O₃, MnO₂ and CoO.
